(19) United States
(12) Patent Application Publication
(10) Pub. No.: US 2007/0070064 A1
(43) Pub. Date: Mar. 29, 2007

(54) Program storage medium storing CAD program for controlling projection and apparatus thereof

(75) Inventor: Masahito Nasu, Fukuoka (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/368,466

(22) Filed: Mar. 7, 2006

(30) Foreign Application Priority Data
Sep. 26, 2005 (JP) 2005-278103

(51) Int. Cl. G06T 15/00

(52) U.S. Cl. 345/419

(57) ABSTRACT

When three-dimensional shape information is represented by a feature-based model, a fillet/chamfer feature is searched for and accumulated. When three-dimensional shape information is not represented by a feature-based model, information of a fillet surface/chamfer surface is searched for and accumulated. From corner shapes accumulated, a corner shape to be removed is selected. The feature or the information of the surface element selected is removed from the three-dimensional shape information. Projection is performed on the basis of the three-dimensional information after the removal, thereby obtaining two-dimensional shape information.

### BACKGROUND OF THE INVENTION

1. Field of the Invention

The present invention relates to computer aided design (CAD) systems. Particularly, the present invention relates to a CAD system that controls projection for converting three-dimensional shape information into two-dimensional shape information.

2. Description of the Related Art

Three-dimensional representation of a product having a three-dimensional structure facilitates recognition of the shape of the product, and also facilitates quick checking of physical interference among the shapes of parts of the product. Thus, in a CAD system, three-dimensional shape information of a product being designed is created and used. In contrast, in a computer aided manufacturing (CAM) apparatus, two-dimensional information representing a planar shape of a product is often more advantageous than three-dimensional shape information. Thus, three-dimensional shape information created by a CAD system is often converted into two-dimensional shape information. For example, Japanese Unexamined Patent Application Publication No.2000-222599 discloses a method of automatically creating a two-dimensional drawing from a three-dimensional model on a CAD system.

Two-dimensional drawings used for processing by a CAM apparatus or the like do not necessarily require precision of details. In some cases, it is even advantageous to use simplified drawings. For example, regarding information of a corner shape, a drawing representing information of the shape and dimension of the corner before processing is more important than a drawing precisely representing information of the shape and dimension of the corner after processing. When two-dimensional information is created simply from three-dimensional shape information, detailed information included in the three-dimensional shape information is reflected precisely. Thus, a two-dimensional projected drawing obtained from the two-dimensional shape information precisely reflects the corner shape after processing.

More specifically, a fillet or a chamfer is sometimes applied to a corner at a projected portion or a recessed portion of a structure. Usually, information of the edge line of the fillet or chamfer portion is not so important in manufacturing a product, and it has often been the case to disregard the information in drawing a two-dimensional projected drawing of the entire product. However, two-dimensional information obtained by converting three-dimensional shape information includes data of the edge line, so that the edge line of the fillet or chamfer portion is displayed in a two-dimensional projected drawing obtained from the two-dimensional shape information.

Generally, such a corner shape is considerably small compared with the size of the entire product. Thus, the corner shape is often invisible when it is displayed on a drawing, so that the drawing apparently looks as if the corner shape is not reflected. Therefore, when the product shape is edited or a dimension line is added on a two-dimensional projected drawing that is based on two-dimensional shape information created by simply converting three-dimensional shape information, data of the edge line of the corner shape might be used for processing by mistake. In order to prevent this situation, it has been necessary to display an enlarged view of a part that is extremely small compared with the size of the entire product, such as a corner shape, and to check a part where a dimension line or the like is added.

### SUMMARY OF THE INVENTION

It is an object of the present invention to provide a CAD system that controls projection for converting three-dimensional shape information into two-dimensional shape information so that a two-dimensional projected drawing can be obtained restraining incorrect editing or addition of an incorrect dimension line.

According to an aspect of the present invention, a program storage medium storing a CAD program is provided. The CAD program allows a computer to execute a surface-element searching step of searching for information of a surface element forming a corner shape from three-dimensional shape information, a surface-element omitting step of omitting the information of the surface element retrieved by the searching from the three-dimensional shape information, and a projecting step of converting the three-dimensional shape information after the omission in the surface-element omitting step into two-dimensional shape information.

According to another aspect of the present invention, a CAD apparatus is provided. The CAD apparatus includes a surface-element searching unit that searches for information of a surface element forming a corner shape from three-dimensional shape information, a surface-element omitting unit that omits the information of the surface element retrieved by the searching from the three-dimensional shape information, and a projecting unit that converts the three-dimensional shape information after the omission by the surface-element omitting unit into two-dimensional shape information. Furthermore, a peripheral device can be connected to the CAD apparatus.

According to these aspects of the present invention, when creating a two-dimensional projected drawing on which a three-dimensional shape is projected, information of a corner shape is omitted in advance from three-dimensional shape information before the three-dimensional shape information is converted into two-dimensional shape information. Thus, even when a product shape is edited or a dimension line is added on the two-dimensional projected drawing, incorrect processing due to the corner shape can be prevented.

### BRIEF DESCRIPTION OF THE DRAWINGS

FIG. 1 is a block diagram schematically showing the configuration of a CAD system according to an embodiment of the present invention;

FIG. 2 is a flowchart according to an embodiment of the present invention;

FIG. 3 is a flowchart of a process of searching for and accumulating a fillet surface;

FIG. 4 is a flowchart of a process of searching for and accumulating a chamfer surface;

FIG. 5 is a flowchart of a process of selecting a corner shape to be removed;

FIGS. 6A and 6B are diagrams showing a first example of addition of an incorrect dimension line;

FIGS. 7A and 7B are diagrams showing a first example of addition of a correct dimension line;

FIGS. 8A and 8B are diagrams showing a second example of addition of incorrect dimension lines;

FIGS. 9A and 9B are diagrams showing a second example of addition of correct dimension lines; and

FIG. 10 is a diagram showing an example of a computer environment.

### DESCRIPTION OF THE PREFERRED EMBODIMENTS

Now, embodiments of the present invention will be described with reference to the drawings.

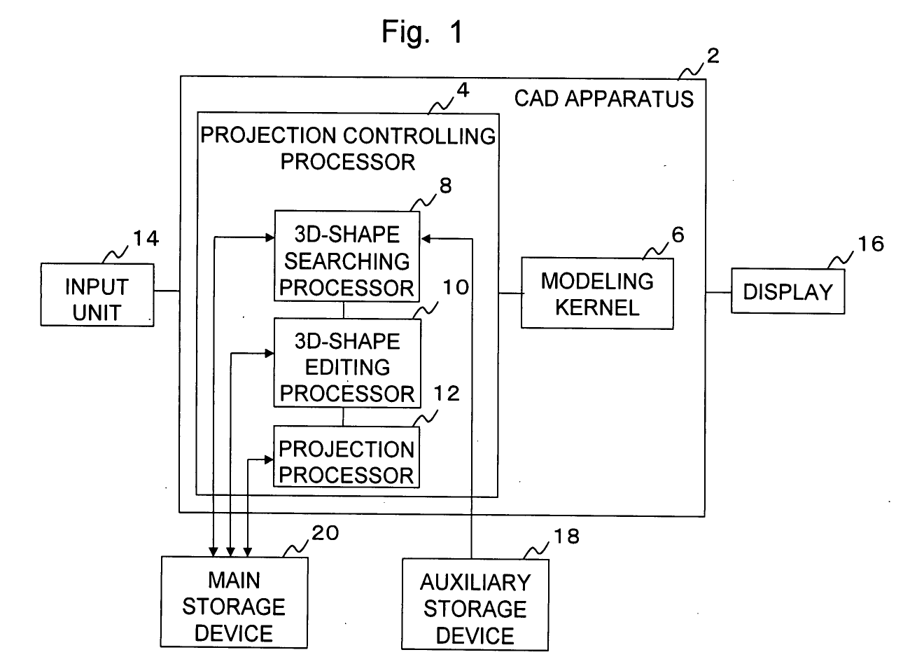

FIG. 1 is a block diagram schematically showing the configuration of a CAD system according to an embodiment of the present invention. A CAD apparatus 2 includes a projection controlling processor 4 that controls projection when three-dimensional shape information is converted into two-dimensional shape information, and a modeling kernel 6 that is a library of functions needed for dealing with three-dimensional shape information. The projection controlling processor 4 controls projection using functions provided by the modeling kernel 6. The projection controlling processor 4 includes a three-dimensional-shape searching processor 8 that searches for three-dimensional shape information, a three-dimensional-shape editing processor 10 that edits three-dimensional shape information, and a projection processor 12 that converts three-dimensional shape information into two-dimensional shape information. The CAD apparatus 2 is connected to an input unit 14 that accepts input by a user, a display 16 that displays drawings generated by the CAD apparatus 2, an auxiliary storage device 18 storing three-dimensional shape information, and a main storage device 20 that stores three-dimensional shapes retrieved by searching, three-dimensional shape information being edited, two-dimensional shape information yielded by converting three-dimensional shape information, and the like.

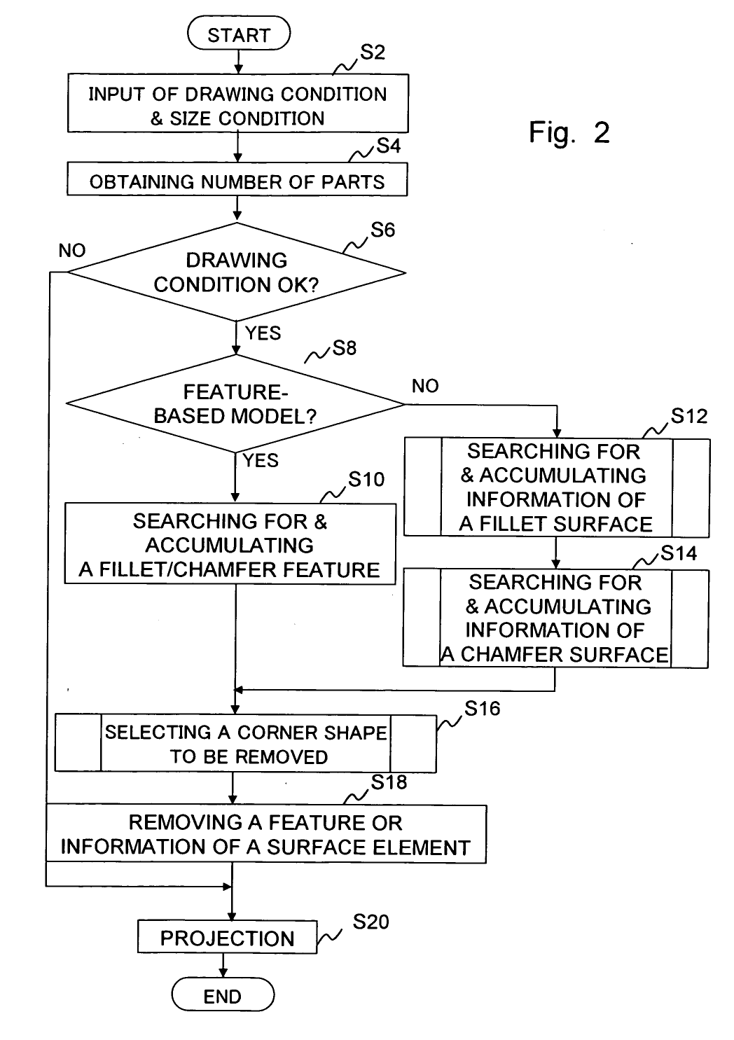

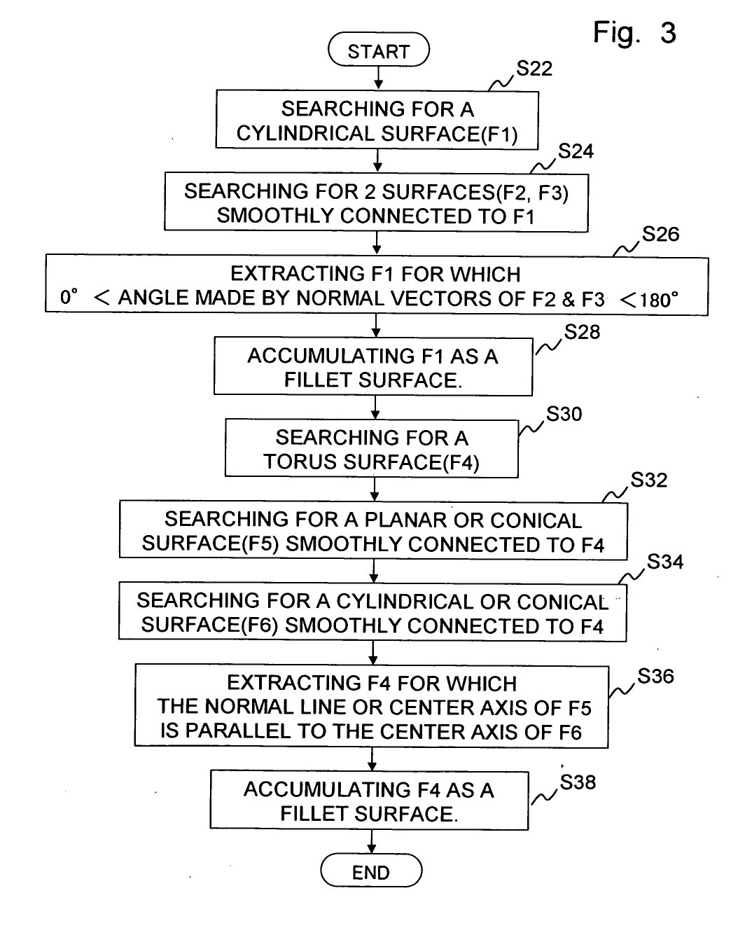

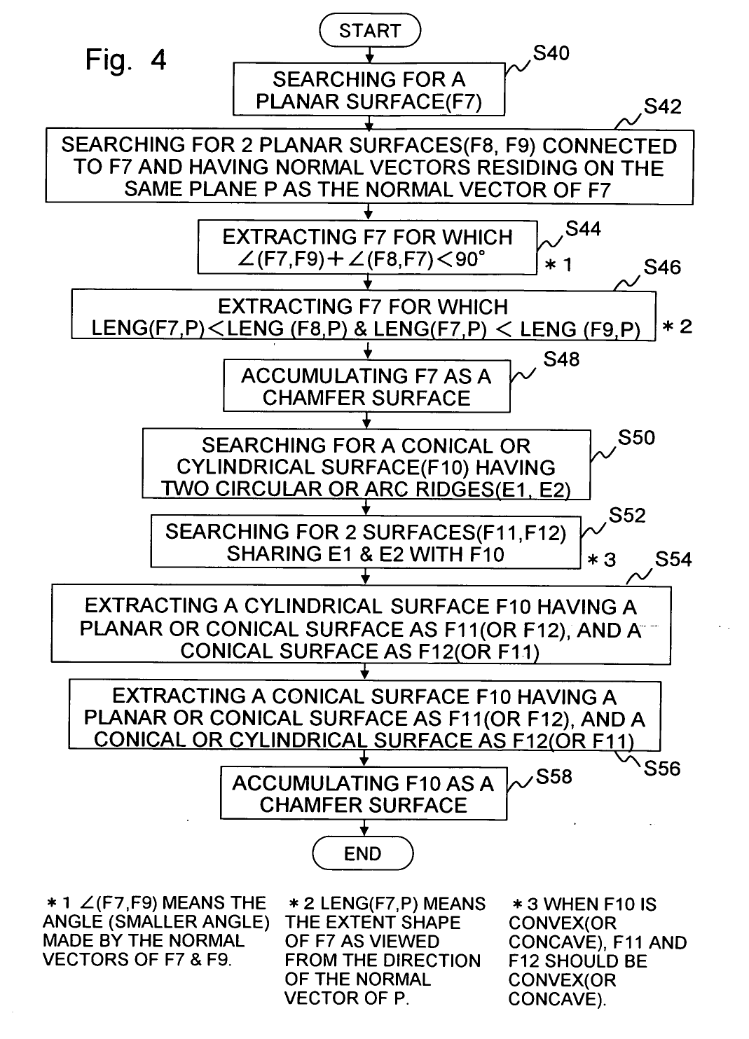

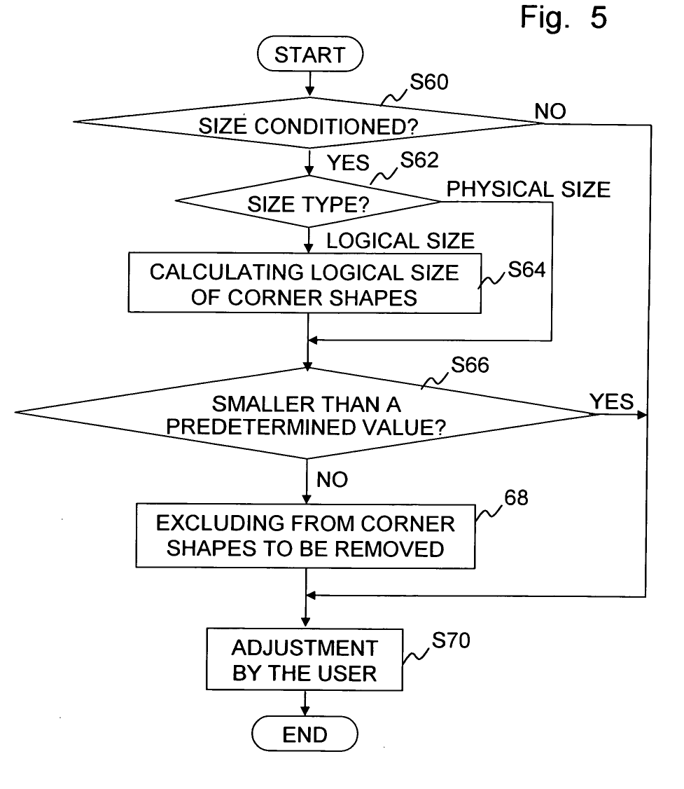

FIG. 2 is a flowchart according to an embodiment of the present invention. FIGS. 3, 4, and 5 respectively show detailed flowcharts of processes shown in FIG. 2, namely, a process of searching for and accumulating a fillet surface (step S12), a process of searching for and accumulating a chamfer surface (step S14), and a process of selecting the shape of a corner to be removed (step S16). Now, the flow of processing according to this embodiment will be described with reference to the flowcharts shown in FIG. 2. Although omission of information of a corner shape in this embodiment will be described by way of an example where corner-shape information is removed, omission of corner-shape information is not limited to removal of corner-shape information. For example, it is possible to replace a corner shape with a simple shape or to modify a corner shape so that the corner-shape information will not be used against a user's intention. That is, omission herein refers to separating secondary information that is not necessary from current information and executing suitable processing to obtain inherent information not affected by the secondary information.

Prior to projection, in step S2, input of a drawing condition and a size condition by a user is accepted. The drawing condition refers to, for example, specification of an assembly drawing or a part drawing, and it specifies a drawing having a corner shape to be removed. The part drawing refers to a drawing showing only a single part, and the assembly drawing refers to a drawing showing two or more parts. The size condition refers to whether only corner shapes not larger than a predetermined size are to be removed (i.e., the size condition is present) or all corner shapes are to be removed regardless of the sizes thereof (i.e., the size condition is absent). When the size condition is specified, a reference size is specified together with specification as to whether the size is calculated in terms of a physical size (a size included in three-dimensional shape information) or in terms of a logical size (a size obtained by multiplying a size included in three-dimensional shape information by a scaling factor of the drawing).

In step S4, the number of parts in the drawing subject to projection is obtained. In step S6, it is checked whether the number of parts complies with the drawing condition. When step S6 results in Yes, in step S8, it is checked whether the three-dimensional information is represented by a feature-based model. When step S8 results in Yes, in step S10, a process of searching for a fillet/chamfer feature is executed, and a result of the searching is accumulated. When step S8 results in No, in step S12, a process of searching for and accumulating a fillet surface is executed, and in step S14, a process of searching for and accumulating a chamfer surface is executed.

In step S16, a corner shape that is to be removed is selected from the corner shapes accumulated. In step S18, the feature or the information of the surface element selected is removed from the three-dimensional shape information. In step S20, projection is performed on the basis of the three-dimensional shape information after the removal, thereby obtaining two-dimensional shape information. When the three-dimensional information is not represented by a feature-based model, in step S18, after removing information of a surface element, a surface element that has been adjacent to the surface element of which information has been removed is extended by a known method so as to cover the portion removed. Furthermore, in step S18, the feature or the information of the surface element removed may be stored so that, when dimension information or the like for the surface element corresponding to the portion removed or otherwise omitted is written on the two-dimensional projected drawing after the removal, the dimension information or the like can be written on the basis of the stored feature or the stored information of the surface element.

Now, the flow of the process of searching for and accumulating a fillet surface will be described. First, in step S22, cylindrical surfaces F1 that serve as candidate fillet surfaces are searched for. In step S24, for each of the surfaces F1, two surfaces F2 and F3 smoothly connected to the surface F1 are searched for. In step S26, surfaces F1 for which the normal vectors of the surfaces F2 and F3 make an angle larger than 0° and smaller than 180° are extracted. In step S28, the surfaces F1 extracted are accumulated as fillet surfaces. Then, in step S30, torus surfaces F4 that serve as candidate fillet surfaces are searched for. In step S32, for each of the surfaces F4, a planar or conical surface F5 smoothly connected to the surface F4 is searched for, and in step S34, a cylindrical or conical surface F6 smoothly connected to the surface F4 is searched for. In step S36, surfaces F4 for which the normal line or center axis of the surface F5 is parallel to the center axis of the surface F6 are extracted. In step S38, the surfaces F4 extracted are accumulated as fillet surfaces.

Next, the flow of the process of searching for and accumulating a chamfer surface will be described. First, in step S40, planar surfaces F7 that serve as candidate chamfer surfaces are searched for. In step S42, for each of the surfaces F7, two planar surfaces F8 and F9 connected to the surface F7 and having normal vectors residing on the same plane P as the normal vector of the surface F7 are searched for. In step S44, surfaces F7 for which the sum of the angle (smaller angle) made by the normal vectors of the surfaces F7 and F9 and the angle (smaller angle) made by the normal vectors of the surfaces F8 and F7 is smaller than 180° are extracted. Furthermore, in step S46, from the surfaces F7 extracted in step S44, surfaces F7 for which the extent shape of the surface F7 is smallest among the extent shapes of the surfaces F7, F8, and F9 as viewed from the direction of the normal vector of the plane P are extracted. In step S48, the surfaces F7 extracted are accumulated as chamfer surfaces.

Then, in step S50, conical or cylindrical surfaces F10 each having two circular or arc ridges E1 and E2 are searched for. In step S52, for each of the conical or cylindrical surfaces F10, surfaces F11 and F12 respectively sharing the ridges E1 and E2 are searched for. At this time, when the surface F10 is convex, convex surfaces F11 and F12 are searched for, and when the surface F10 is concave, concave surfaces F11 and F12 are searched for. As for surfaces F10 having cylindrical shapes, in step S54, surfaces F10 for which one of the surfaces F11 and F12 is a planar or conical surface and the other is a conical surface are extracted. In step S58, the surfaces F10 extracted are accumulated as chamfer surfaces. As for surfaces F10 having conical shapes, in step S56, surfaces F10 for which one of the surfaces F11 and F12 is a planar or conical surface and the other is a conical or cylindrical surface are extracted. In step S58, the surfaces F10 extracted are accumulated as chamfer surfaces.

Next, the flow of the process of selecting a corner to be removed will be described. First, in step S60, it is checked whether the size condition is present. When step S60 results in No, all the corner shapes accumulated are left as corner shapes to be removed, and the process proceeds to step S70 in which corner shapes to be removed are adjusted by the user. When step S60 results in Yes, the size type is checked in step S62. When it is determined in step S62 that the size is a physical size, the size is checked in step S66 using the information included in the three-dimensional shape information. On the other hand, when it is determined in step S62 that the size is a logical size, in step S64, the logical sizes of all the corner shapes accumulated are calculated by multiplying information included in the three-dimensional shape information by the scaling factor of the drawing. In step S66, the sizes are checked using the values of the logical sizes, and the size of each of the corner shapes accumulated is compared with a specified size to check whether the size is smaller than the specified size. When step S66 results in Yes, the corner shape is left as a corner shape to be removed. When step S66 results in No, the corner shape is excluded from corner shapes to be removed in step S68. Lastly, in step S70, the corner shapes to be removed are adjusted individually by the user.

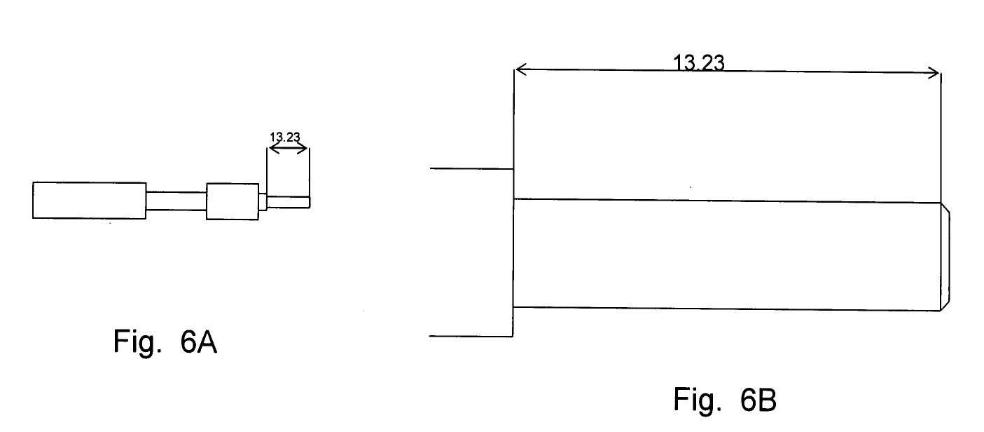

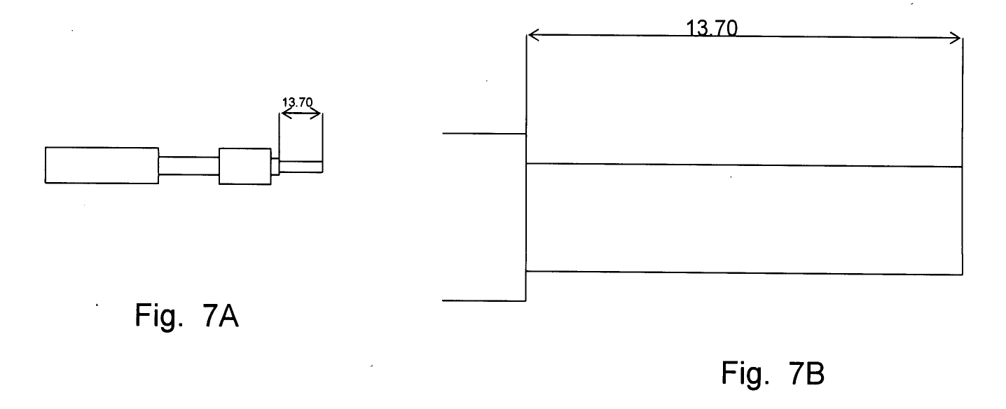

Now, specific examples will be described. FIGS. 6A and 6B are diagrams showing a first example of an incorrect dimension line added by a CAD system according to the related art. FIG. 6A shows a part drawing having a certain scaling factor, and FIG. 6B is an enlarged view of a part thereof. Referring to FIG. 6A, when it is instructed to add a dimension line to a projecting portion at the right end by specifying the upper edge thereof, a dimension of 13.23 is displayed. However, as shown in FIG. 6B, chamfering has been performed at the right end, so that the dimension actually represents the length up to the edge line of chamfering. As described above, in the case of projection according to the related art, three-dimensional shape information is accurately reflected on two-dimensional shape information. In order to avoid this situation, prior to projection, information of the chamfer portion is removed from the three-dimensional shape information, and projection is then performed to convert the three-dimensional shape information into two-dimensional shape information. FIGS. 7A and 7B are diagrams showing a first example of a correct dimension line added by the CAD system according to this embodiment. FIG. 7A is a part drawing having a certain scaling factor, and FIG. 7B is an enlarged view of a part thereof. As shown in FIG. 7B, since information of a chamfer portion is not included in two-dimensional information, when it is instructed to add a dimension line at a projecting portion at the right end in FIG. 7A by specifying the upper edge thereof, a dimension of 13.70 is displayed.

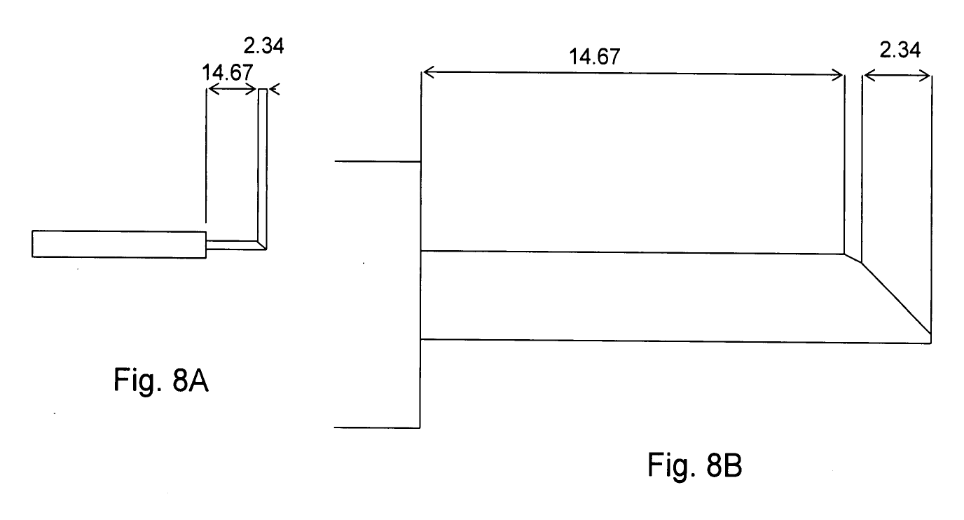

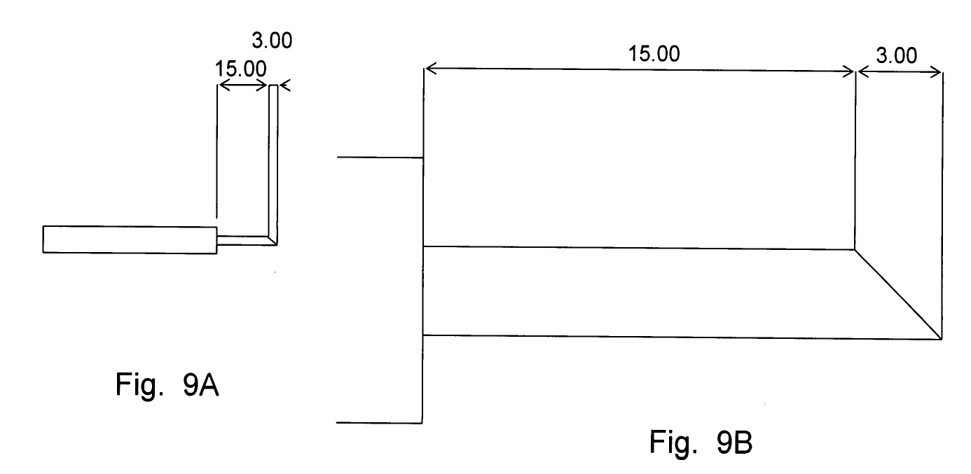

FIGS. 8A and 8B are diagrams showing a second example of an incorrect dimension line added by the CAD system according to the related art. FIG. 8A is a part drawing having a certain scaling factor, and FIG. 8B is an enlarged view of a part thereof. Referring to FIG. 8A, when it is instructed to add dimension lines to a projecting portion at the right end by specifying the upper edge and oblique edge thereof, dimensions of 14.67 and 2.34 are displayed. However, since chamfering is performed as shown in FIG. 8B, the dimensions actually represent lengths up to chamfer edge lines. FIGS. 9A and 9B are diagrams showing a second example of correct dimension lines added by the CAD system according to this embodiment. FIG. 9A is a part drawing having a certain scaling factor, and FIG. 9B is an enlarged view of a part thereof. As shown in FIG. 9B, since information of a chamfer portion is not included in two-dimensional shape information, when it is instructed to add dimension lines at a projecting portion at the right end in FIG. 9A by specifying the upper and oblique edges thereof, dimensions of 15.00 and 3.00 are displayed.

As described above, according to this embodiment, information of a corner shape can be excluded from two-dimensional shape information obtained by converting three-dimensional information. Thus, incorrect processing due to a corner shape can be prevented when editing is performed or a dimension line is added on a two-dimensional projected drawing.

The CAD system according to the embodiment described above may be implemented in hardware or in computer software. For example, a program for allowing a computer to execute functions of the three-dimensional-shape searching processor 8, the three-dimensional-shape editing processor 10, and the projection processor 12 shown in FIG. 1 is created so that the projection controlling processor 4 shown in FIG. 1 can be implemented by loading the program in a memory of the computer and executing the program.

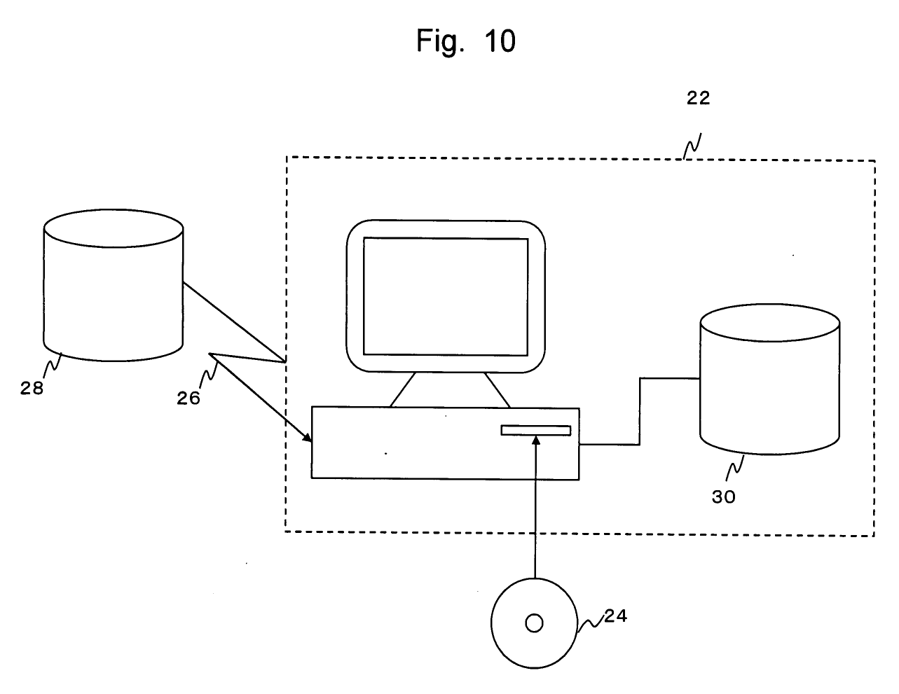

The program for implementing an information presenting apparatus according to the embodiment may be stored in a portable recording medium 24 such as a CD-ROM, a CD-RW, a DVD-R, a DVD-RAM, a DVD-RW, or a flexible disk, a storage device 28 provided at the other end of a communication circuit 26, a storage device such as a hard disk, a RAM, or the like of a computer system 22, or a recording medium 30 of the computer system 22, as shown in FIG. 10. When the program is executed, the program is loaded and executed on a main memory.

What is claimed is:

1. Program storage medium readable by a computer, tangibly embodying a program of instructions executable by the computer to perform method steps of computer aided design, said method comprising:
a surface-element searching step of searching for information of a surface element forming a corner shape from three-dimensional shape information;
a surface-element omitting step of omitting the information of the surface element retrieved by the searching from the three-dimensional shape information; and
a projecting step of converting the three-dimensional shape information after the omission in said surface-element omitting step, into two-dimensional shape information.

2. The program storage medium of claim 1, said method further comprising:
an omitted-information storing step of storing the information of the surface element omitted in said surface-element omitting step, the information of the surface element being associated with the three-dimensional shape information from which the information of the surface element has been omitted.

3. The program storage medium of claim 1, the three-dimensional shape information being represented by a feature-based model, said surface-element omitting step comprising:
a sub-step of removing a feature corresponding to the surface element from the three-dimensional shape information.

4. The program storage medium of claim 1, said surface-element omitting step comprising:
a sub-step of removing the information of the surface element retrieved by the searching from the three-dimensional shape information; and
a sub-step of extending an adjacent surface element that has been adjacent to the surface element of which information has been removed.

5. The program storage medium of claim 1, the two-dimensional shape information being obtained by converting one or more sets of the three-dimensional shape information, said method further comprising:
a number-of-parts checking step of determining whether information of the surface element is to be omitted in accordance with the number of sets of three-dimensional information.

6. The program storage medium of claim 1, said method further comprising:
a size-checking step of searching for a small surface element having a size smaller than a predetermined value.

7. The program storage medium of claim 6, said method further comprising:
a size-designating step of accepting designation of the predetermined value.

8. The program storage medium of claim 6, the size of the surface element being checked in said size-checking step using a physical value included in the three-dimensional shape information.

9. The program storage medium of claim 6, the size of the surface element being checked in said size-checking step using a logical value obtained by multiplying a physical value included in the three-dimensional shape information by a certain scaling factor.

10. The program storage medium of claim 6, said method further comprising:
a displaying step of displaying the surface element retrieved in said size-checking step as an object to be omitted; and
a modifying step of accepting an instruction of changing the object to be omitted.

11. CAD apparatus connectable to a peripheral device comprising:
a surface-element searching unit for searching for information of a surface element forming a corner shape from three-dimensional shape information;
a surface-element omitting unit for omitting information of the surface element retrieved by the searching from the three-dimensional shape information; and
a projecting unit for converting the three-dimensional shape information after the omission by said surface-element omitting unit, into two-dimensional shape information.

12. The apparatus of claim 11 further comprising:
an omitted-information storing unit for storing information of the surface element omitted by said surface-element omitting unit, the information of the surface element being associated with the three-dimensional shape information from which the information of the surface element has been omitted.

13. The apparatus of claim 11, the three-dimensional shape information being represented by a feature-based model, said surface-element omitting unit comprising:
a sub-unit for removing a feature corresponding to the surface element from the three-dimensional shape information.

14. The apparatus of claim 11, said surface-element omitting unit comprising:
a sub-unit for removing the information of the surface element retrieved by the searching from the three-dimensional shape information; and
a sub-unit for extending an adjacent surface element that has been adjacent to the surface element of which information has been removed.

15. The apparatus of claim 11, the two-dimensional shape information being obtained by converting one or more sets of the three-dimensional shape information, further comprising:
a number-of-parts checking unit for determining whether information of the surface element is to be omitted in accordance with the number of sets of three-dimensional

16. The apparatus of claim 11 further comprising:
a size-checking unit for searching for a small surface element having a size smaller than a predetermined value.

17. The apparatus of claim 16, further comprising:
a size-designating unit for accepting designation of the predetermined value.

18. The apparatus of claim 16, the size of the surface element being checked by said size-checking unit using a physical value included in the three-dimensional shape information.

19. The apparatus of claim 16, the size of the surface element being checked by said size-checking unit using a logical value obtained by multiplying a physical value included in the three-dimensional shape information by a certain scaling factor.

20. The apparatus of claim 16, further comprising:
a displaying unit for displaying the surface element retrieved by said size-checking unit as an object to be omitted; and
a modifying unit for accepting an instruction of changing the object to be omitted.
